(19) United States
(12) Patent Application Publication
(10) Pub. No.: US 2009/0128899 A1
(43) Pub. Date: May 21, 2009

(54) OPTICAL SYSTEM PROVIDING OPTICAL MAGNIFICATION

(76) Inventor: Michael Newell, Santa Rosa, CA (US)

Correspondence Address: DERGOSITS & NOAH LLP, Suite 1450, Four Embarcadero Center, San Francisco, CA, 94111, US

(21) Appl. No.: 12/271,619

(22) Filed: Nov. 14, 2008

Related U.S. Application Data
(60) Provisional application No. 60/988,917, filed on Nov. 19, 2007.

(51) Int. Cl. G02B 23/00

(52) U.S. Cl. 359/399

(57) ABSTRACT

An optical system for the magnification of an object presented to an image receiver. The optical system includes a frame configured to position at least one optical element between the object and the image receiver. The optical element includes a plurality of Galilean telescopes supported on a substrate, each Galilean telescope being composed of a positive lens and negative lens, the positive lens being further distanced from the image receiver than the negative lens when the object element is positioned between the object and image receiver. Each of the Galilean telescopes has an axis substantially parallel to the axis of the other Galilean telescopes in the optical system such that light passing through each of the plurality of Galilean telescopes is substantially collimated. Ideally, each negative lens is positioned on a substrate to be on a spherical radius whose center of curvature is substantially at the image receiver.

### RELATED APPLICATIONS

This application relies on provisional application Ser. No. 60/988,917 filed on Nov. 19, 2007.

### TECHNICAL FIELD

The present invention relates to a new and novel optical system providing optical magnification.

### BACKGROUND OF THE INVENTION

From a historical perspective, conventional telescopes and binoculars are some of the earliest demonstrated forms of optical magnifiers. In general, these tend to be afocal magnifiers as they are viewed directly from the human eye. Binoculars include two telescope systems, one for each eye. In order to present an erect magnified image, binoculars employ telescope design forms such as the prior art Galilean telescope depicted in FIG. 1. Schematically this is shown as system 10 or in erecting telescope of the prior art referred to as system 20 of FIG. 2.

The earliest telescopes and binoculars from the 17^{th} century employ the Galilean form as shown in FIG. 1 with positive power objective lens 11 and negative power eyepiece lens 12, the magnification of the telescope being calculated as to ratio of the focal lengths M=F/f as the image is read by eye 13 of an observer. The advantage of this design form is its simplicity and that it provides an inherently erect (and magnified) image. Furthermore, it is relatively lightweight and reasonably compact, which are important traits for head-worn binoculars. Disadvantages include a narrow field of view and an inability to achieve high magnifications. Generally, Galilean telescopes are limited to magnifications less than approximately 4×, and today are found in very limited applications such as opera glasses, head-worn binocular vision aids for people with eye problems such as macular degeneration, and very inexpensive binocular models.

The vast majority of binoculars manufactured and sold today employ an erecting telescope as depicted in FIG. 2. Specifically, FIG. 2 shows telescope 20 including positive objective lens 21 and positive power eyepiece lens 22 employing Porro prisms 23 to invert the image form by the telescope. Without the Porro prisms, the magnified image would appear to be upside down to the person using the binoculars. Manufacturers also use roof prisms as an alternative to Porro prisms. The erecting telescope is capable of high magnifications and relatively wide fields of view, when compared with the Galilean telescope. They are, however, relatively bulky and heavy, and for these reasons are not generally practical for use in head-mounted applications.

Observers of an event, in particular sports fans, concert-goers and opera-goers, often use binoculars to observe the event from a distance. Binoculars are typically operated with one or both hands. This is sometimes problematic, for example, during a sporting event, since a sports fan cannot simultaneously watch the game through binoculars and perform other activities that require the use of hands.

While various hands-free binoculars have been proposed, they are often expensive and not optimally designed in form and function for the requirements of the sports fan, concert-goer or opera-goer in mind. For example, U.S. Pat. No. 2,422,661 issued Jun. 24, 1947 to C. A. Ellis, describes a binocular magnifying lens holder. U.S. Pat. No. 2,437,642 issued Mar. 9, 1948 to F. C. P. Henroteau, describes spectacles for vision correction. U.S. Pat. No. 3,741,634 issued Jun. 26, 1973 to Stoltze, describes binocular spectacles.

Further, U.S. Pat. No. 4,429,959 issued Feb. 7, 1094 to Walters, describes a spectacle mounted hinged monocular or binocular vision aid. U.S. Pat. No. 5,485,305 issued Jan. 16, 1996 to Johnson, describes a lightweight binocular telescope. U.S. Pat. No. 6,002,517 issued Dec. 14, 1999 to Elkind, describes flat, hands-free, convertible Keplerian binoculars.

Some of the most sophisticated head-worn binoculars available today are the head-worn binocular vision aids for people with eye problems such as macular degeneration. They are still relatively bulky (which affects their wider acceptance for broader applications), and their weight is significant as well. The Eschenbach Model 1634 is an example of this type of binocular magnifier, with a magnification of 3×, a field of view of 9.5 degrees, and a weight of 70 grams. These binoculars are typically mounted in a pair of custom spectacle frames. Generally, the nearest optical surface to the eye for a pair of spectacles or head-mounted optics is approximately 15 mm in front of the eye. The telescopes then extend a further 20-25 mm from the eye in the case of the Eschenbach 1634 model as an example. This significant weight at a distance from the eye tends to exert a torque on the head and leads to neck strain when used for extended viewing periods.

In order to reduce the weight of the head-worn binoculars, one of the approaches employed has been to use all plastic optics (rather than glass lenses as normal), and some models have used a Fresnel lens for the objective. This does serve to reduce the overall weight, but still has the same basic form as in FIG. 1 with a positive objective lens and a negative eye lens. So, the length of the telescope is still the same, making it rather bulky and unwieldy, and is a limitation of this design approach. Design models using this approach include the MAX TV and MAX Event models from Eschenbach.

Another challenge for headworn magnifiers or binoculars is that the size of the human head varies from one person to the next. The distance between the left eye and the right eye, or interpupillary distance (IPD), varies from individual to individual as well. In order to accommodate this variation in IPD, binoculars generally incorporate an adjustment mechanism allowing the spacing between the left eye telescope and the right eye telescope to vary. The binocular user can then adjust the binocular IPD spacing for maximum comfort. As an example, the IPD of the Eschenbach Model 1634 can be adjusted between a minimum of 54 mm and a maximum of 74 mm. These adjustments are well understood and accommodated, but it does require additional mechanical complexity and cost.

The limitations of the prior art are that the constraints of a standard Galilean telescope mean that the system is by nature heavy and bulky as discussed. If one prioritizes size, weight and field of view as the primary design goals, it is possible to conceive of a very lightweight and compact optical system that employs multiple apertures to create a composite overlayed image of a scene over a wide field of view. An example is to use multiple miniature Gililean telescopes in specific orientation to each other to create a composite image that is indistinguishable to the viewer or detector from an image created by a regular single aperture telescope system.

The applications for such a system are many, including, but not limited to, a wide angle attachment for camera systems, afocal magnifier for rifle scopes and night vision systems, telescope and binocular systems, and others as will be obvious to those skilled in the art.

There is very little prior art to be found in this area of multiple aperture magnifiers, telescopes or binoculars of this nature. Wirth, et al., U.S. Pat. No. 5,270,859, discusses configurations of micro-optic multiplets (MOM) which include a limited 2-dimensional array of Galilean telescopes, the disclosure of which is incorporated by reference.

It is therefore an object of the present invention to provide an improved optical system for providing optical magnification—in particular utilizing a multi-aperture approach. Further and more specifically it is an object of the present invention to provide a head-worn binocular that is extremely lightweight and has a center of mass close to the face (reducing torque on the head and resulting neck fatigue), has a wide field of view, and provides a large eyebox (zone within which eye pupil can move without significant vignetting) eliminating the need for any IPD adjustment mechanism.

### SUMMARY OF THE INVENTION

An optical system for the magnification of an object presented to an image receiver, said optical system comprises a frame configured to position at least one optical element between said object and said image receiver said optical element comprising a plurality of Galilean telescopes supported on a substrate, each Galilean telescope comprising a positive lens and negative lens, said positive lens being further distanced from said image receiver than said negative lens when said optical element is positioned between said object and image receiver, each of said Galilean telescopes having an axis substantially parallel to the axes of other Galilean telescopes in said optical system such that light passing through each of said plurality of Galilean telescopes is substantially collimated. The plurality of Galilean telescopes can be positioned anywhere in 3-dimensional space as long as placement does not occlude adjacent elements. Ideally, each negative lens is positioned on said substrate to be on a spherical radius whose center of curvature is substantially at the image receiver.

### BRIEF DESCRIPTION OF THE FIGURES

FIG. 1 is a side schematic illustration of a typical Gililean telescope of the prior art.

FIG. 2 is a side partially cut away view of an erecting telescope of the prior art.

FIG. 3 is a side schematic illustration of an array of Galilean telescopes arranged pursuant to the present invention.

FIGS. 4A, 4B and 4C are front views of the alternative geometries of Galilean telescopes as possible examples of the present invention.

FIGS. 5 and 6 are side schematic illustrations of positive/negative lens pairs useful in practicing the present invention.

FIGS. 7 and 10 are perspective views of pairs of spectacles supporting an array of Galilean telescopes as an illustration of an embodiment of the present invention.

FIGS. 8 and 9 are alternative Galilean telescope arrays useful in the practice of the present invention.

FIG. 11 is a side schematic view of a Galilean telescope array illustrating the phenomenon of cross-talk observed in using the present invention.

FIGS. 12A, B and C illustrate masks or baffles both schematically and in perspective in addressing the cross-talk phenomenon illustrated in FIG. 11.

FIGS. 13A and 13B are side schematic illustrations of Galilean telescope arrays illustrating variations in spacing between the plurality of positive and negative lenses.

FIG. 13C is a side schematic illustration of an array of Galilean telescopes optimized at different field angles.

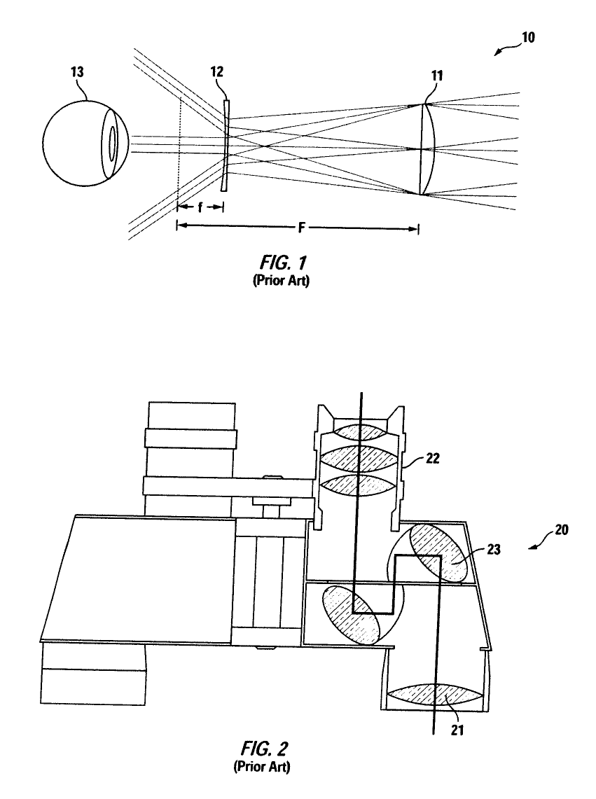

### DETAILED DESCRIPTION OF THE INVENTION

The basic building block of this invention is a miniaturized Galilean telescope. One of the most important properties of a Galilean telescope is that the emerging light which travels to the eye (or is focused onto a detector or imaging system) is collimated or very nearly collimated. This property allows one to construct a composite imaging system that employs a plurality of these miniaturized Galilean telescopes, with the telescopes arranged arbitrarily in 3-dimensional space. The critical thing required in order to ensure that the composite image (made up of the superposition of the images emerging from each of the miniaturized Galilean telescopes) appears to be a single seamless image, and the image quality is not significantly affected, is that the axes of each of the miniaturized Galilean telescopes must be substantially parallel. This design approach allows a much more general and versatile system than disclosed by the prior art. The plurality of miniaturized Galilean telescopes can be positioned anywhere in 3-dimensional space, with the practical constraint that the placement should not occlude adjacent elements.

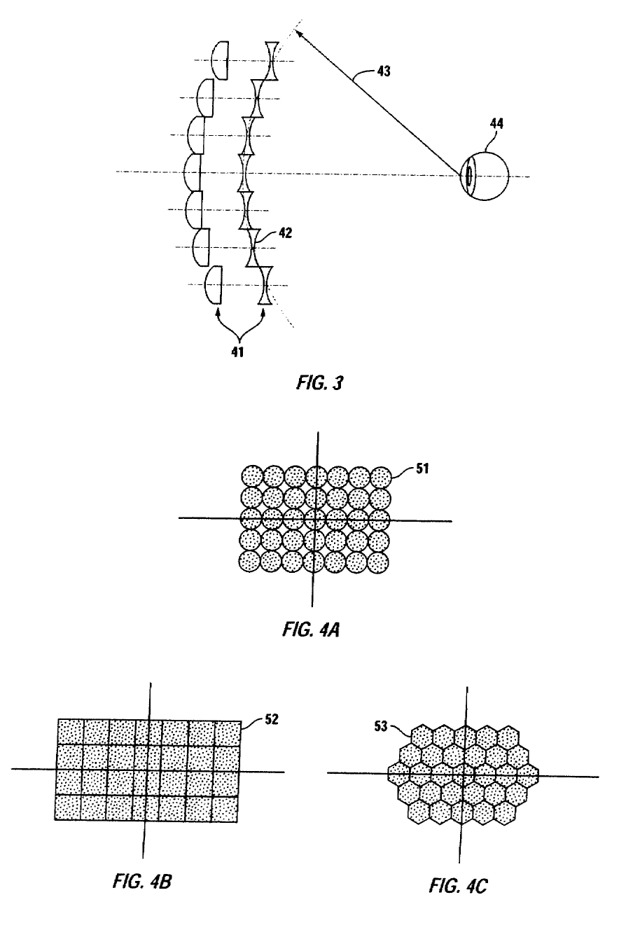

An example of the utility and versatility of this approach is demonstrated in FIG. 3 which shows the plurality of miniaturized Galilean telescopes 41 arranged such that rear negative lenses 42 fall on a spherical radius 43 whose center of curvature is at the center of the pupil of image receiver 44, in this instance, an eyeball. One of the advantages this embodiment provides when employed in a headworn application is that it keeps the center of mass as close to the eye/face as possible, thus reducing the torque on the head and resulting neck fatigue. Clearly, a spherical surface is just an example and many different surfaces and 3-dimensional configurations can be considered for this and other applications.

The lenses can be made from normal optically transparent materials such as glass and plastic. For headworn applications, molding the array out of plastic will have advantages over glass with regard to weight minimization. On the other hand, for applications requiring a more durable system capable of withstanding harsh environments (e.g. military applications), glass will have advantages. Furthermore, glass has many more available types with different properties compared with the limited set of plastic materials available. Use of higher index glasses and better color matching will allow better correction of aberrations and better viewing performance. Applications involving wavelength ranges other than the visible can be accommodated by judiciously selecting materials that are optically transparent in the appropriate wavelength range.

One of the practical tradeoffs of the present invention is that while it has advantages in weight, head torque, field of view, and eyebox when compared with a standard Galilean telescope, it suffers from reduced brightness. This is due to the fact that the present invention does not have the same pupil magnification in object space as a standard Galilean telescope. The system shown in FIG. 4 has an effective pupil in object space (or entrance pupil) which is identical to the limiting diameter of the eye pupil. A standard Galilean telescope has an entrance pupil whose size is M×(eye pupil diameter), where M is the magnification of the telescope. So, to first order, the present invention will suffer a loss of brightness when compared with a standard Galilean telescope of 1/M². For example, if the telescope magnification M=3, then the present invention will have 1/9 the brightness of a standard Galilean telescope (to first order). Some of this loss will be mitigated by the pupil of the eye expanding in low light conditions, but it will tend to limit the practical application of this invention to magnifications less than approximately 5× without external illumination or other gain in the system.

FIGS. 4A, 4B and 4C show a number of different options for the aperture of the lenslets making up the system. Many common optical systems have circular apertures, but as can be seen in FIG. 4A, array 51 will not maximize the amount of light through the system. Improved system brightness can be achieved by utilizing contiguous array 52 of rectangular apertures as shown in FIG. 4B. An excellent blend of good system performance, improved system brightness and most efficient packing will be achieved with array 53 of hexagonal apertures as shown in FIG. 4C.

The focus of the system can be adjusted by changing the spacing between the array of front positive lenses and the array of rear negative lenses. A mechanical adjustment mechanism can be introduced in order to change this spacing and adjust focus for each eye. In order to minimize cost, one implementation of the present invention will involve setting the spacing to a fixed distance and having no adjustment mechanism. With a fixed distance between the arrays, in order to maximize the depth of field, it is best to set the focus of the system not at infinity (in object space) but rather at a closer distance such as 50 to 75 feet. By doing this, the system maintains good focus between infinity and approximately 10-15 feet. The fact that the apertures of the lenslets are small also tends to give excellent depth of field.

Turning now to the miniaturized Galilean telescopes that are replicated to make the present composite optical system. Perhaps the simplest and lowest cost approach is to utilize all spherical surfaces. The Galilean telescope 60 shown in FIG. 5 having positive lens 61 and negative lens 62 utilizes all spherical surfaces and has the following prescription. The optical system shown in FIG. 3 could be made up of identical telescopes, and an exemplary prescription for such a design is presented as an example:

| | Lens 1 | Airgap | Lens 2 |
|---|---|---|---|
| Form | Positive meniscus | | Bi-concave |
| Material | Acrylic | | Polycarbonate |
| First radius (mm) | 4.337 | | −2.746 |
| Second Radius (mm) | 134.515 | | 5.981 |
| Axial thickness (mm) | 1.50 | 4.682 | 1.50 |
| Lens Diameter (mm) | 3.00 | | 3.00 |

The above example represents a substantially afocal system with the following properties:

| | |
|---|---|
| Angular magnification | 3.0 |
| Field of view (total) | 15 degs (in object space) |

The on-axis performance is limited by spherical aberration and off-axis performance is limited by lateral color. In order to more easily analyze this afocal system, the scale of these diagrams (and all subsequent spot diagrams and ray fans) has been chosen to correspond to micro-radians. For example, the on-axis spot radius is 1113 micro-radians, which corresponds to approximately 4 minutes of arc.

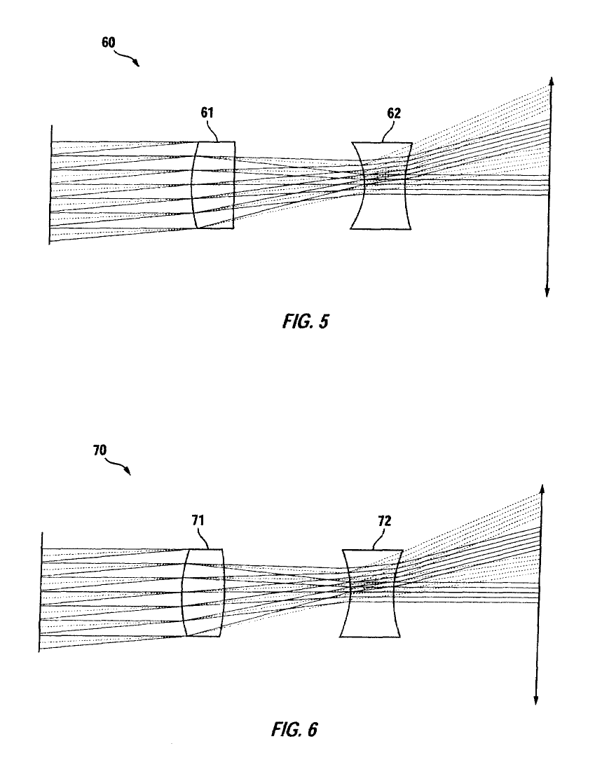

In order to improve the performance of the system, aspherical surfaces can be employed. Examples of aspherical elements that can be introduced include conic surfaces, or perhaps polynomial aspheric surfaces (odd or even). In particular, the limiting on-axis spherical aberration apparent in the all-spherical design, is significantly reduced by the introduction of simple conic surfaces to the design. FIG. 6 shows an improved telescope 70 having positive lens 71 and negative lens 72 utilizing conic surfaces. The prescription for the improved Galilean telescope in FIG. 6 is as follows:

| | Lens 1 | Airgap | Lens 2 |
|---|---|---|---|
| Form | Bi-convex | | Bi-concave |
| Material | Acrylic | | Polycarbonate |
| First radius (mm) | 5.979 | | −3.574 |
| First surface conic | −1.000 | | 0 |
| Second Radius (mm) | −15.721 | | 4.031 |
| second surface conic | −2.982 | | 0 |
| Axial thickness (mm) | 1.50 | 4.839 | 1.50 |
| Lens Diameter (mm) | 3.00 | | 3.00 |

It was observed that the on-axis performance has improved significantly over the telescope of FIG. 5. The spherical aberration that limited on-axis performance has largely been eliminated, leaving primary axial color as the limiting aberration. The spot diameter with this design is now approximately 5 minutes of arc, as compared with approximately 8 minutes of arc for the all spherical design. The off-axis performance is again limited by coma and lateral color which is so typical and problematic for Galilean telescopes, but again has been reduced to approximately 50 minutes of arc in total. The human eye is quite tolerant of lateral color and should be able to tolerate this level of lateral color at the edges of the field.

Further performance improvement can be achieved by the use of binary or diffractive surfaces. As the residual aberration limiting overall system performance is lateral color, diffractive surfaces can prove helpful in reducing this and thus improving system performance.

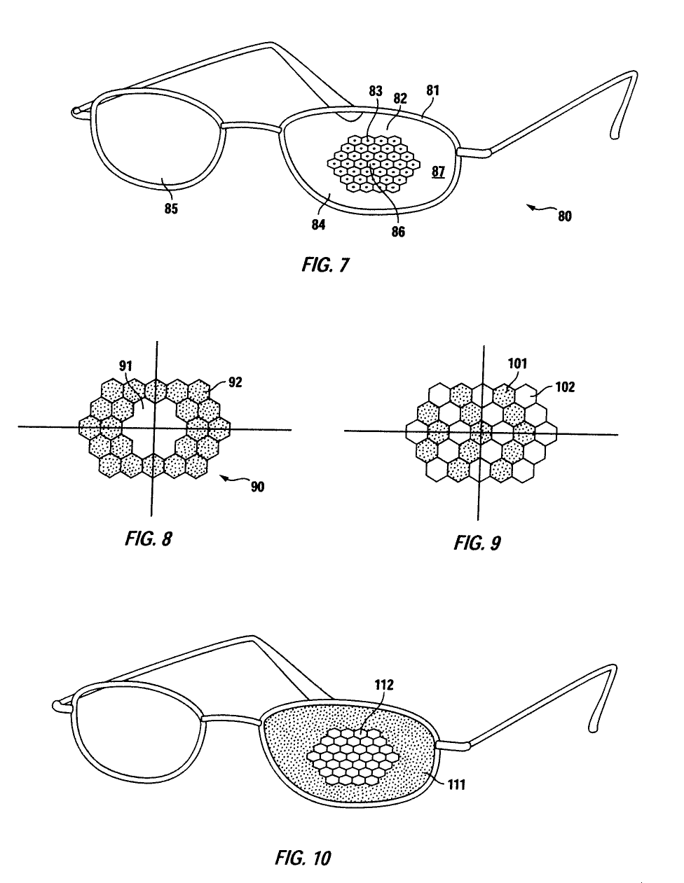

FIG. 7 shows another preferred embodiment of this invention. A very compact, wide-angle head-worn binocular 80 is depicted by combining the following elements:
A set of spectacle frames 81 (molded plastic or metal frame or other common frame styles and materials)
A multiple aperture telescopic system 82 for the right eye which comprises:
   An integrated front optical element which combines a plurality of positive lenses along with the optical blank 85. This could be achieved by providing mounting features to clip into the spectacle frames 81 (not shown).
   An integrated rear optical element which combines a plurality of negative lenses along with optical blank 85. This could be achieved by providing mounting features to clip into the spectacle frames 81 (not shown).
A multiple aperture telescopic system for the left eye which comprises:
   An integrated front optical element which combines a plurality of positive lenses 83 along with optical blank 84. This could be achieved by providing mounting features to clip into the spectacle frames 81 (not shown).
   An integrated rear optical element which combines a plurality of negative lenses along with optical blank 84. This could be achieved by providing mounting features to clip into the spectacle frames 81 (not shown).

The positive and negative lenses are ideally arranged on a curved surface as disclosed and illustrated in FIG. 3, and configured as individual miniaturized Galilean telescopes which combine to make an integrated seamless image. As shown in FIG. 7, the faceted structure of the multi-aperture optical system can be built into the lens blank as a single molded component, and then integrated with a pair of spectacle frames. As described previously, there is no need for IPD adjustment as the eye can move around and still see the scene which is not the case with standard binoculars that have a limited and fixed pupil size.

FIG. 7 shows a configuration which has the magnifier array 82 placed on and about the geometric center 86 of lens blank 84 for each eye, and has clear section 87 surrounding it.

Another configuration that may be useful is shown in FIG. 8. In this instance, an array of Galilean telescopes 92 surrounds clear unobstructed center 91 of optical system 90. Thus, multiple aperture Galilean telescopes 92 provide magnification around the edges of the system. Another alternative is shown in FIG. 9 where lens facets 101 alternate with clear sections 102, allowing the opportunity to introduce a mask which can be moved to alternately select a magnified image or an un-magnified image.

Another configuration is shown in FIG. 10 whereby instead of having a clear section surrounding central magnifying area 112, the surrounding area 111 is opaque. This will tend to shield the eye or detector from unwanted stray light and allow the pupil to open to its maximum extent in low light conditions.

In general, the number of miniaturized Galilean telescopes (or lenslet facets) should be sufficient to provide the desired field of view.

The present invention when configured into headworn binoculars may find application at sporting events, concerts, plays and with opera-goers as an example. The frames can be molded or painted in team colors and adorned with team logos or identification at prominent locations such as the temples or bridge. Also, team colors or national colors or other insignia or colors or trademarks could be painted or otherwise applied to the lens blank in the section surrounding the magnifier in order to make that section opaque, as described in the configuration above. This has the benefit of providing additional promotional real estate as well as shielding the eye or detector from unwanted stray light and allowing the pupil to open to its maximum extent in low light conditions.

A further embodiment of the invention involves a configuration which incorporates diopter and aberration correction, as would normally be found in prescription spectacles or contact lenses. This would allow the extension of utility to those who would otherwise need vision correction optics.

Another method of accommodating those people who need vision correction or visual aids is to integrate left eye and right eye multiple aperture telescopes (as previously described) with a clip-on mechanism that will allow them to be attached to normal prescription spectacles.

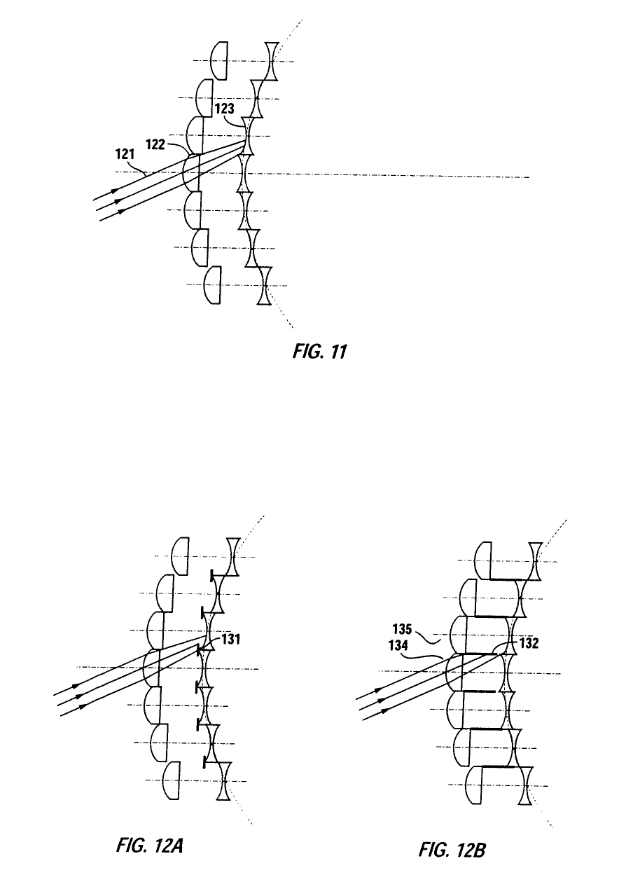

Cross-talk is a phenomenon for undesirable stray light to reach the eye or detector. As shown in FIG. 11, cross-talk occurs when high angle light 121 emerging from the front positive lenslet 122 strikes an adjacent negative lenslet rather than the matching negative lenslet that makes up the miniaturized Galilean telescope. In order to mitigate cross-talk, reference is made to FIGS. 12A, B and C, illustrating a mask or baffle that can be employed between the front positive lenses and the rear negative lenses of the optical system. The mask is in general a transverse obscuration or series of obscurations 131 or 132 placed to limit the field of view as shown in FIGS. 12A and B. The baffle system of FIG. 12C comprises a honeycomb system where the walls of the baffle 132 provide isolation between adjacent miniaturized Galilean telescopes 134 and 135.

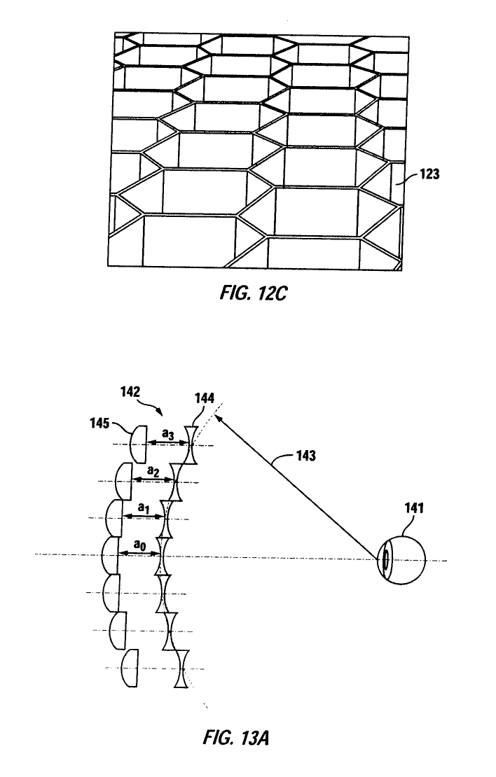

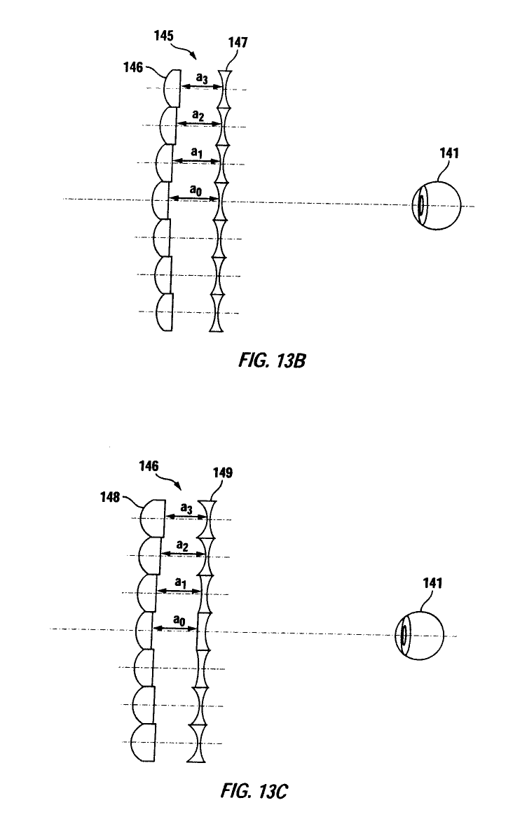

Further variations of this invention can be more readily appreciated by considering FIGS. 13A, 13B and 13C. Generally these figures illustrate the use of a plurality of non-identical miniaturized Galilean telescopes to create a seamless composite image.

System performance can be further refined by optimizing the telescopes at the center of the system separately from the telescopes at the edge of the field. The image as observed by the image receiver 141 is made up of the superposition of all of the images formed by each individual Galilean telescope. The center of the field of view, as observed by the image receiver, tends to be transmitted through the telescopes at the center of the system. The higher field angles (which correspond to the edge of the apparent field of view), as observed by the image receiver, tend to be transmitted by the telescopes at the edge of the system. Consequently, optimizing the telescopes separately and differently can provide improved performance. It is of critical importance to maintain constant magnification and to match distortion from individual telescope to telescope when optimizing in order to maintain an apparently seamless image when all the individual images are superimposed.

Turning first to FIG. 13A, image receiver 141, in the form of an eyeball, is located at the center of curvature of telescope array 142 distanced from negative lenses 144 by radius 143. Spacing between positive lenses 145 and negative lenses 144 shown as A₀, A₁, A₂, and A₃ vary to provide the goals recited above.

FIGS. 13B and 13C depict arrays 145 and 146 respectively whereby in FIG. 13B, the spacing between positive and negative lenses 146 and 147 is again varied by the distance A₀, A₁, A₂ and A₃. As to FIG. 13C, positive lenses 148 and negative lenses 149 not only are variably spaced, but the geometry of the telescopes themselves vary in order to, again, to be selectively optimized to give improved performance.

What is claimed is:

1. An optical system for the magnification of an object presented to an image receiver, said optical system comprises a frame configured to position at least one optical element between said object and said image receiver said optical element comprising a plurality of Galilean telescopes supported on a substrate, each Galilean telescope comprising a positive lens and negative lens, said positive lens being further distanced from said image receiver than said negative lens when said optical element is positioned between said object and image receiver, each of said Galilean telescopes having an axis substantially parallel to the axes of other Galilean telescopes in said optical system such that light passing through each of said plurality of Galilean telescopes is substantially collimated and wherein said plurality of Galilean telescopes are positioned so that each Galilean telescope does not substantially occlude an adjacent Galilean telescope.

2. The optical system of claim 1 wherein each negative lens is positioned on said substrate to be on a spherical radius whose center of curvature is substantially at the image receiver.

3. The optical system of claim 1 wherein said image receiver is an eye of an observer.

4. The optical system of claim 3 wherein said frame comprises an eyeglass frame and said substrate comprises optical lenses configured within said frame.

5. The optical system of claim 3 wherein each negative lens is positioned on said optical lenses to be on a spherical radius whose center of curvature is substantially at the center of the pupils of the observer's eyes associated with each said optical lens.

6. The optical system of claim 1 wherein said optical element comprises a member selected from the group consisting of optical glass and optical plastic.

7. The optical system of claim 1 wherein said optical element comprises a plurality of Galilean telescopes, each of said Galilean telescopes comprises substantially rectangular apertures nested in said substrate.

8. The optical system of claim 1 wherein said optical element comprises a plurality of Galilean telescopes, each of said Galilean telescope comprising substantially hexagonal apertures nested in said substrate.

9. The optical system of claim 1 wherein the focus of said plurality of Galilean telescopes is less than approximately 75 feet.

10. The optical system of claim 1 wherein said positive lens is characterized as having at least one conic surface.

11. The optical system of claim 10 wherein said positive lens is characterized as having single convex or bi convex surfaces.

12. The optical system of claim 1 wherein said negative lens is characterized as having biconcave surfaces.

13. The optical system of claim 1 wherein said positive or negative lenses are characterized as having diffractive surfaces.

14. The optical system of claim 1 wherein said lenses are characterized as having flat surfaces.

15. The optical system of claim 1 wherein said lenses are characterized as having spherical surfaces.

16. The optical system of claim 1 wherein said lenses are characterized as having aspheric surface.

17. The optical system of claim 1 wherein said substrate is characterized as having a perimeter and geometric center within said perimeter, said plurality of Galilean telescopes being nested on and proximate to said geometric center.

18. The optical system of claim 1 wherein said substrate is characterized as having a perimeter and geometric center within said perimeter, said geometric center being devoid of said plurality of Galilean telescopes.

19. The optical system of claim 1 wherein said plurality of Galilean telescopes are nested with areas of said substrate devoid of said Galilean telescopes.

20. The optical system of claim 17 wherein said substrate is opaque in areas not occupied by said Galilean telescopes.

21. The optical system of claim 4 wherein said optical lenses are characterized as exhibiting optical correction as necessitated by the needs of said observer.

22. The optical system of claim 1 wherein said combination of said frame and image receiver comprises clip-on optical lenses configured for removable attachment to a pair of eyeglasses.

23. The optical system of claim 1 further comprising a baffle positioned between said positive and negative lenses.

24. The optical system of claim 23 wherein said baffle comprises a honeycomb providing isolation between adjacent Galilean telescopes.

25. The optical system of claim 1 wherein all Galilean telescopes within said plurality of Galilean telescopes are of a constant magnification.

26. The optical system of claim 25 wherein not all Galilean telescopes within said plurality of Galilean telescopes display constant field of view.

27. The optical system of claim 25 wherein not all Galilean telescopes within said plurality of Galilean telescopes display a constant spacing between said positive and negative lenses.
